(19) United States
(12) Patent Application Publication
(10) Pub. No.: US 2016/0063811 A1
(43) Pub. Date: Mar. 3, 2016

(54) Systems and Methods Related to Tracking Game Points

(71) Applicant: Big Daddy Games LLC, Menasha, WI (US)

(72) Inventor: Eric J Jacobson, Menasha, WI (US)

(21) Appl. No.: 14/841,197

(22) Filed: Aug. 31, 2015

Related U.S. Application Data
(60) Provisional application No. 62/043,885, filed on Aug. 29, 2014.

(51) Int. Cl. G07F 17/32; G06K 9/00

(52) U.S. Cl. CPC G07F 17/3237; G07F 17/3216; G07F 17/3295; G06K 9/00006

(57) ABSTRACT

Systems and methods related to a video game loyalty program include storage of points separate and apart from a user identification device, such as a magnetic stripe card, which preferably contains only a unique identifier. Separate loyalty accounts associated with the same unique identifier may be set up and maintained at separate geographic locations, such as at different buildings, restaurants, taverns, etc.

### RELATED APPLICATIONS

This patent application claims priority to and the benefit of co-pending U.S. provisional patent application Ser. No. 62/043,885, filed Aug. 29, 2014, and entitled “Systems and Methods Related to Tracking Game Points,” which is incorporated by reference herein in its entirety.

### BACKGROUND OF THE INVENTION

Systems and methods according to the present invention relate generally to electronic gaming, and more particularly to the tracking, redeeming and awarding of electronic gaming points.

Prior systems and methods related to “player loyalty programs” are known, especially in casinos at which regulated gaming may take place. For instance, players enrolling in such program often receive a magnetic swipe card. An account is created for accumulating reward points associated with that swipe card. The unique player account is created on a computer system that allows multiple geographic locations (e.g., commonly owned casino locations) both read and read/write access to the card, on which points are stored.

When playing a slot machine, for instance, a player inserts the card into a card reader/writer affixed to the slot machine, and the card usually must remain in the machine reader during play for points to accumulate on the card. Points may be earned and accumulated by players based on the amount of play (e.g. total money bet). Reward points from the card can usually be redeemed for special prizes, gifts, tickets, hotel stays, special rates and discounts. Reward points from the card may alternatively be earned from other businesses, usually associated with a casino.

While prior user points systems and methods exist, there remains a need for improvements, such as specific location point tracking and/or availability and/or storage of point accounts remote from user.

### SUMMARY OF THE INVENTION

Systems and methods according to the present invention provide improvements related to electronic game player loyalty systems including specific location point tracking and/or availability and/or storage of point accounts remote from user. Enrollment in a system according to the present invention involves an identification device, such as a magnetic swipe card, RFID tag or biometric identifier. The identification device is used to locate a datastore accessible by a local network server at a particular location (e.g. building), and preferably does not contain or store any other information, or minimal other information, to enhance security in the event of a lost identification device.

Accessible to the server are data records (e.g., datastores) each including a primary account number or other location-unique identifier associated with a player credit balance (i.e., credits available to a player) and a location point balance (i.e., potential credits to be transferred to the player credit balance). Other information may be stored in the datastores, such as a “tick rate,” which is used in incrementing the location point balance,

Since a person, player, or user account is preferably only on a particular location's server, the account in which player credits are stored is accessible and usable only at that location. If a player wants to use an identification device in another location they must preferably enroll and create an account for that location.

After an identification device is verified, a player can bank player credits before, during and after game play. Banked credits are accessible and transferable to and from any gaming device connected to that location's network server, thus serving as a “bank” for storing credits.

### BRIEF DESCRIPTION OF THE DRAWINGS

FIG. 1 is a diagrammatic representation of a first embodiment of a system according to the present invention.

FIG. 2 is a partial display view of an embodiment of a display according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

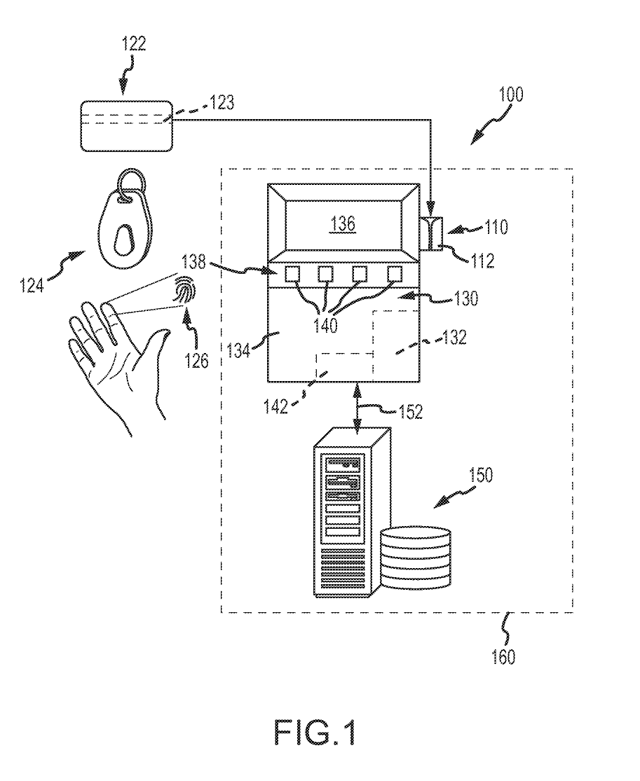

Turning now to the figures, FIG. 1 depicts an embodiment 100 of a system according to the present invention. The system 100 generally includes an identification interface 110 communicatively coupled with a gaming device 130 and/or a server 150, which themselves are in communication. The identification interface 110 may be a magnetic card reader 112, such as a reader compatible with ISO/IEC 7813 standard (and standards referenced therein). Compatible with the identification interface 110 is an identification device 120, such as a magnetic stripe card 122, a radio frequency identification (RFID) fob or tag 124, or even a biometric identifier, such as a finger print 126. Respective identification interfaces 110 are known in the art.

Where a card reader 112 is used as the identification interface 110, the reader 112 is preferably capable of reading at least one of track 1 data, track 2 data, and track 3 data, from a magnetic stripe 123 on the card 122. While various information may be stored on the card 122, at least a primary account number is included, the account number being unique with respect to all account numbers stored on the server 150. Preferably, only a primary account number is stored on the card 122, while other information associated with the account number is stored on the server 150. Such data arrangement may improve security by minimizing the information stored on and accessible from the device 120. Thus, the identification device 120 serves as a physical activation device to be used according to the methods described herein.

The identification interface 110 is in communication with the gaming device 130 and/or the server 150. The gaming device 130 generally has a central processing unit 132 or motherboard, which contained within a cabinet 134. The central processing unit 132 controls a visual output display 136 (e.g., LCD, which may comprise a capacitive touch screen) and receives input from a user input interface 138, which preferably includes a plurality of buttons 140. The central processing unit 132 includes hardware and software for controlling the gaming unit 130 and facilitating the functionality herein described. A communications interface 142 is also included, preferably in the cabinet 134, which allows the gaming device 130 to communicate 152 with the server 150. The communication 152 may be wired (e.g., universal serial bus (USB), Ethernet) or wireless (e.g., WiFi (IEEE 802.11), Bluetooth), and the server 150 may be located within the cabinet 134, but is preferably located at the same building or site location 160 as the gaming device 130. The server 150 may communicate with a plurality of gaming devices 130 at the location 160 over a local area network (LAN) or wide-area network (WAN), which may be wired or wireless.

As indicated above, the server 150 preferably stores information associated with a primary account number, such as that represented by magnetically encoded data on a card, by an RFID circuit, or by a biometric identifier. The server 150 preferably stores the primary account number, and associates with that account number such information as one or more of a person's name, personal identification number (PIN or security code), location point balance, player credit balance, and an incentive bonus increase rate (or tick rate).

A game play incentive program may be implemented using systems according to the present invention. An incentive method may utilize the software and hardware of the gaming devices 130 and the server 150 to create a location point balance accounting related to game play at a particular location 160, which may include game play at a plurality of gaming devices 130 at the location 160.

Use of the system 100 generally includes enrollment of an identification device 120 (e.g., creation of an account), verification of an identification device (e.g., sign-on), game play, and points or credits management. To enroll an identification device 120, a person receives the device 120, such as by requesting one from an owner/operator of a location 160, or through the use of a vending machine at the location 160. The identification device 120 has a primary account number that has not heretofore been used at the location 160 or is not at present being used at the location 160. The person uses the identification device 120 in conjunction with the respective identification interface 110 coupled to a gaming device 130 of their choice. For example, a magnetic card 122 is swiped through a card reader 112. The reader 112 conveys or provides the primary account number that was read from the card stripe 123 to the server 150, either directly or through the gaming device 130. If the account number has not been previously registered on the server 150 at the location 160, one or more data entry renderings can be displayed on the display 136, requiring user input from the person/player. Various fields of data may be required or optional, including the person's name (first name and/or last name), telephone number, e-mail address, etc. The data may be entered by the person through the display 136 (e.g., touchscreen) or through one or more buttons 140 or other user input mechanisms. The screen 136 may display a full keyboard, such as a QWERTY keyboard, for data entry. Information entered by the person may be confirmed and accepted (e.g., by electing to “save” or “accept” the information after reviewing it for accuracy and editing as desired). The person may then be presented with an alpha and/or numeric keypad for establishing a personal identification number (PIN) or password. While the PIN could be written to a magnetic card 122, all information entered by the person is preferably transferred to the server 150 and associated with the primary account number in a datastore. An account is thus created on the server 150, including at least the primary account number and PIN/password, and then the server creates fields to be associated with the primary account number, including at least a location point balance and a player credit balance. An an incentive bonus increase rate (or “tick” rate) field may also be included.

Verification of an identification device (e.g., sign-on) is undertaken when a person wishes to associate game play with their account having been previously created. When associated game play is desired, a person uses his or her identification device 120 in conjunction with the respective identification interface 110 coupled to a gaming device 130 of their choice. For example, a magnetic card 122 is swiped through a card reader 112. The reader 112 conveys or provides the primary account number that was read from the card stripe 123 to the server 150, either directly or through the gaming device 130. If the account number is not recognized by the server 150, then the enrollment process, described above, is executed. If the account number is recognized by the server 150, the person may be prompted to enter a PIN/password for verification. Upon entry of an incorrect PIN/password, conventional error handling may be undertaken, such as splash screen(s) and/or additional sign on attempts. Optionally, an account may be locked upon a certain number of incorrect PIN/password entries within a predetermined amount of time (e.g., three incorrect PIN/password entries in ten minutes).

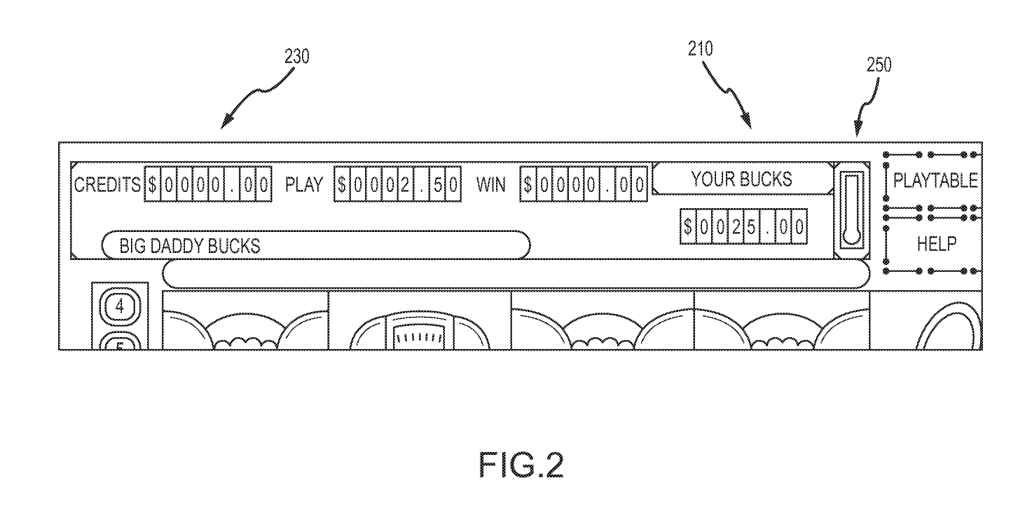

With reference also to FIG. 2, upon entry of a correct PIN/password, the gaming device 130 displays normal game play according to its software, with some additional functionality displayed, including a first point value (e.g. displayed as a number of points, as representative “dollars”, etc.) comprising a location point balance (e.g., credit pool balance) 210 and a player credit balance (e.g., player credits) 230. Other functionality options or information may be displayed such as account access and the person's name. The location point balance consists of all points earned at the respective location 160 according to the “tick” methodology described herein. This point balance may be initially seeded with some value (e.g., $10.00 or 1000 points) when the person first obtains the identification device. Credits must be used for game play. Credits may be added for game play by the person, such as by inserting money into the gaming device 130 by using cash, coins, or even a credit card, which will increase the player credit balance. Additionally or alternatively, credits may be transferred preferably automatically at pseudo-random intervals from the location point balance to be used for game play. During game play, the player credit balance 230 increases and decreases according to the rules of the game. However, the location point balance 210 is incremented according to a predetermined calculation during the game play. For instance, the location point balance may be incremented according to a particular percentage rate (or “tick” rate or TR) multiplied by the number of credits played during game play (e.g., about 0.05% to about 5% of credits played, and more preferably about 0.25% to about 1% of credits played). The tick rate may be displayed on the display 136 as a number, or more preferably a graphic 250, such as a thermometer or needle gauge.

The tick rate may be static or variable for a given game play session. For instance, a static tick rate may increment the location point balance linearly throughout a game play session (e.g., for the entire time a person is signed in with a respective primary account number and associated PIN/password), such as a static rate of 0.5% of credits played. This static tick rate may be adjusted before and/or after a game play session according to a predetermined calculation. For example, the tick rate may be increased for persons that play a minimum amount of credits during a game session or over some predetermined time period, or decreased for persons that do not play a predetermined number of credits, either per game session or over a predetermined time period of minutes, hours, days, weeks, or months. Additionally or alternatively, the tick rate may adjust during a game session, in which case the graphic 250 (e.g., thermometer or gauge) may change (e.g., color or shape change) to indicate a change in the tick rate. For instance, the tick rate may increase with the number of credits played by the person, or it may increase or decrease by a certain event happening within the game. The tick rate may have a floor value and/or a ceiling value for any game session, such as about 0.25% to about 1.0%. Thus, the modified location point balance LPB_{mod} is calculated from the previous location point balance LPBₚᵣₑᵥ as follows:

LPB_{mod}=LPBₚᵣₑᵥ+TickRate*CreditsPlayed+GameBonus

Where TickRate is the incentive bonus increase rate associated with the primary account number of the person, the CreditsPlayed is the amount of credits played for a particular game attempt or played collectively over some predetermined time or over some predetermined number of game plays, and the GameBonus may be a random, pseudo-random, or predetermined bonus amount of points to be awarded, if any.

The tick rate may be decreased, such as after a particular number of bonus game plays, or by some other methodology, such as if a minimum amount of player credits are not banked at the end of a game session (as described below).

During game play, some credits may be automatically transferred from the location point balance to the player credit balance. The transferred credits are subtracted from the location point balance total and are automatically transferred to the player credit balance, which are available for continued play, collection and/or banking, or a combination thereof, as determined by the person.

The amount of automatically transferred credits may be a random, pseudo-random, or predetermined static or variable percentage of the location point balance. When an amount of the location point balance is transferred to the player credit balance, the gaming device 130 may display a special screen message to the person indicating that they have been awarded a certain number of credits.

Before, during or after game play, while signed in, a player may manage his or her player credit balances by banking or collecting the credits. A player may elect to bank player credits for future use at the location. The player may elect to collect credits, at which time, a ticket may be printed so that the player may redeem the credits at the location 160, such as for prizes or food, drink, or service discounts. The player has the option to bank or collect some or all of the player credit balance. If the entire player credit balance is collected by the player, the tick rate may be decreased, or even reset to an initial value. If the entire player credit balance is banked by the player, then that balance remains associated with the active primary account number for use on a gaming device 130 at some future time. If the player wants to collect only a portion of the player credit balance, then the player may select or enter a number credits to collect, and the remainder will be banked. A player may then sign-off of the game session, or sign-off may occur automatically after a predetermined time of inactivity, in which case all of the player credit balance will be automatically banked. The location point balance is preferably preserved as associated with the primary account number on the server after sign-off.

The foregoing is considered as illustrative only of the principles of the invention. Furthermore, since numerous modifications and changes will readily occur to those skilled in the art, it is not desired to limit the invention to the exact construction and operation shown and described. For instance, the precise location of the player credit balance and the location point balance when same are modified is of no consequence. That is, whether the balances are modified directly in the datastore accessible to the server or a copy of them is made locally on a gaming device, then modified, then rewritten to the datastore, both methodologies are envisioned. While the preferred embodiment has been described, the details may be changed without departing from the invention, which is defined by the claims.

I claim:

1. A system comprising:
an electronic gaming device;
a local network server in communication with the electronic gaming device, the local network server having access to a datastore including an association of a primary account number, a player credit balance, and a location point balance;
an identification interface in communication with at least one of the electronic gaming device and the local network server; and
an identification device compatible with the identification interface;
wherein, after the identification device is verified by the electronic gaming device, game play on the electronic gaming device results in a collection of points in the location point balance on the network server, and
wherein, during game play, pseudo-randomly transferring a portion of the location point balance to the player credit balance.

2. A system according to claim 1, wherein the electronic gaming device comprises a game of skill.

3. A system according to claim 1, wherein the identification interface comprises a card reader and the identification device comprises a card having a magnetic strip.

4. A system according to claim 3, wherein the card reader is capable of reading data from at least one of track 1 data, track 2 data, and track 3 data on the card.

5. A system according to claim 3, wherein the magnetic strip includes encoding of only a primary account number.

6. A system according to claim 1, further comprising a cabinet housing the electronic gaming device.

7. A system according to claim 6, wherein the cabinet houses the network server.

8. A method comprising the steps of:
identifying a physical identifier using an identification interface communicatively coupled to at least one of a gaming device and a local network server;
accessing, by at least one of the gaming device and the local network server, a datastore associated with the physical identifier, the datastore comprising:
a primary account number;
a personal identification number;
a player credit balance; and
a location point balance;
receiving input to initiate a game session at the gaming device;
during the game session, as a result of game play, increasing the location point balance at a predetermined rate; and
during game play, pseudo-randomly transferring a portion of the location point balance to the player credit balance.

9. A method according to claim 8, wherein the gaming device comprises a game of skill.

10. A method according to claim 8, wherein the physical identifier is a card carrying a magnetic stripe.

11. A method according to claim 8, wherein the physical identifier is a radio frequency identification tag.

12. A method according to claim 8, wherein the physical identifier is a human biometric identifier.

13. A method according to claim 12, wherein the human biometric identifier comprises a fingerprint.
